(19) United States
(12) Patent Application Publication
(10) Pub. No.: US 2003/0140769 A1
(43) Pub. Date: Jul. 31, 2003

(54) Method and system for creating and performing music electronically via a communications network

(75) Inventors: Keith C. Davis, Beverly Hills, CA (US); Wade M. Erickson, Lake Elsinore, CA (US)

Correspondence Address: PAUL, HASTINGS, JANOFSKY & WALKER LLP, P.O. BOX 919092, SAN DIEGO, CA, 92191-9092, US

(73) Assignee: Muzik Works Technologies Inc.

(21) Appl. No.: 10/062,238

(22) Filed: Jan. 30, 2002

(51) Int. Cl. G10H 1/26

(52) U.S. Cl. 84/609

(57) ABSTRACT

A method and system for creating and/or performing music via the Internet. The music is created and/or performed at a client system using a software application and sound tone-banks/loops delivered via a server system. The server system responds to an authorized user's request to transmit the necessary application and tone-banks/loops to the client, thereby creating a complete environment where the user can actuate the tones in the tone-bank or loops and store the actuation events locally or on a remote system for later retrieval.

### TECHNICAL FIELD

The present invention relates to a computer method and system for creating and performing music and, more particularly, to a method and system for creating and performing music over the Internet.

### BACKGROUND OF THE INVENTION

The Internet is comprised of a large number of computers and computer networks that are connected via various communications protocols (e.g., HTTP, FTP, POP3, SMTP) that utilize numerous technologies for delivering functionality to a client computer. The interconnected computers exchange information using various services including the World Wide Web (“WWW”). The WWW service allows a server computer and application to provide storage of files and manage the delivery of functionality predominately through what is referred to as web pages. Navigation to these unique web pages on the network is specified using a Uniform Resource Locator (“URL”) that identifies the computer server that stores the files and the name of the file of interest. These web pages generally use various markup languages (e.g., HTML, XML, XSL, Javascript) that allow for presentation of text, graphics, audio and video media, and other formats of informational data. These web pages can also provide a support environment for displaying additional technologies often referred to as active content that provides enhanced interaction with the delivered content versus the static content that is usually represented as text, graphics, audio, or video. These active technologies (e.g., ActiveX or Java Applets/Applications) allow for the delivery of greater functionality to the client system that is not available in static web pages, particularly in trying to access system resources on the client computer such as a sound card, MIDI port, USB Port, or local storage. Additionally, the programming technologies on the server and within the web page content presentation can change based on evaluatible events (e.g., mouse clicks and keyboard keys selections both up and down) and parameters such as a person's logon profile or events that might be entered on the client's side or stored on the server side. A person with a computer and a software system referred to as a “browser” can connect to the network such as the Internet via a telephone line or other means to gain access to the server and these web pages that deliver the active technologies and information and the accompanying ability to interact with the information and functionality presented.

By taking advantage of these active technology approaches, applications can be generated that deliver desired functionality dynamically over the network allowing which is similar in functionality to that provided in traditional software applications that are “installed” on the client's computer. By delivering the application via the network connection, the active components allow for reduction in the time necessary to release enhancements to the application, as well as improvements in the application's ability to access centralized resources.

During the last 20 years, electronics and computer software has changed the way music can be created. Special electronic based music instruments can send the actuation information via a communication standard called Musical Instrument Digital Interface (“MIDI”). This standard communications channel allows music instruments and computers to capture the actuation events of the instruments and pass the event information to additional devices for additional processing or signaling to external devices to activate a specified sound.

The challenge to the current environment is that often the musician's performance and recording environment require numerous pieces of equipment that may or may not include a computer. Sharing of one musician's performances and recordings with another musician is further complicated by proprietary storage formats among software vendors, as well as the high likelihood that the musician's environment is somewhat incompatible because of the numerous pieces of hardware (e.g., keyboards, tone generators, computer system, locally installed software, etc.) involved in the creation environment. These challenges reduce the ability of musicians to collaborate across geographically separate environments. The mixture of equipment, software, network connectivity, and file formats requires additional efforts to establish even partial compatibility, and often the ability of micro-editing of parts between the composers is lost.

Additionally, the costs of developing these music creations environments can also be out of the range of younger aspiring artists due to the numerous hardware devices and costs of software licenses of the applications that are installed on a computer when a computer is involved in the environment.

It has therefore appeared desirable to the inventors to provide a shared application delivery system and methods that substantially reduce the requirements for varying equipment across creation environments, and that facilitate common storage formats with ease of access to a common support application that has a shared family of sounds in the form of tone-banks and loops to create music.

### SUMMARY

The following is a summary of various aspects and advantages realizable according to various embodiments of the invention. It is provided as an introduction to assist those skilled in the art to more rapidly assimilate the detailed design discussion which ensues and does not and is not intended in any way to limit the scope of the claims which are appended hereto in order to particularly point out the invention.

Accordingly, a system and method is provided hereafter for communication of a software application across a network. The application provides the user with a common feature set of applications for creating audio works which is not dependent on the previous environments that the work was created/edited in. This feature allows for remote performance and editing across diverse environments as well as geographic locations. This approach creates a more homogenous environment across users of the client systems, which increases compatibility of works and products of the users to support multi-locations performances, which in turn facilitates sharing of works for collaboration among multiple users of the client system.

According to another aspect, a user is provided with a low-cost system that integrates various features to create audio works, which features include common interactive software, common tonebanks/loops, and actuation capability which reduces the dependence on additional hardware and software beyond a computer with a sound performance device (e.g., sound card), operating system, and access to the communications network. Actuation devices other than the computer keyboard and mouse can be added for additional flexibility in capturing the performance.

The method and system hereinafter disclosed may also provide for multiple storage options for both local and remote, for the users of the client system to provide greater flexibility in sharing works for collaboration efforts. An embodiment of the present invention further expands the options of the computer network to include traditional local area networks, the Internet and World Wide Web, peer-to-peer networks, and wireless networks such as those for Cellular devices and PDAs. Private networks such as those in hotels, which provide games, movies, and other applications, could also be used. Major improvements are realizable in collaboration among users who create music from electronic and technological apparatus as well as in wider availability of audio tones, loops, sound effects, and other audio presentments in a centralized manner. Digital delivery of the client active components improves availability of tools to create music and audio works as well providing a more homogenous software applications environment.

### BRIEF DESCRIPTION OF THE DRAWINGS

The accompanying drawings, which are incorporated in and constitute a part of the specification, illustrate presently preferred implementations and are described as follows:

FIG. 1 is a block diagram of apparatus useful in practicing one embodiment of the present invention.

FIG. 2 is a portion of a flow diagram illustrating a procedure for using apparatus such as that of FIG. 1 to create and edit a music work.

FIG. 3 is the remainder of the flow diagram of FIG. 2.

FIG. 4 is a flow diagram setting forth primary steps in creation, editing, and storage of a music work according to an embodiment of the invention.

FIG. 5 is a flow diagram illustrating network delivery of an interactive application in accordance with one embodiment of the present invention.

FIG. 6 is a flow diagram further illustrating interaction with new and existing works according to an embodiment of the present invention.

FIG. 7 is a flow diagram further illustrating creation and editing of independent parts/sections of the work.

FIG. 8 is a flow diagram further illustrating storage of a work to support a collaborative environment.

FIG. 9 is an examplary user interface in accordance with one embodiment of the present invention.

FIGS. 10-16 are flow charts illustrating the structure and operation of an active component.

### DETAILED DESCRIPTION OF PREFERRED EMBODIMENTS

The preferred embodiments provide a method and system for creating audio works such as music in a client/server environment. The audio works creation environment hereafter described reduces the dependence on external devices other than those of a standard computer with a sound performance device (e.g., sound card). The keyboard and mouse devices provide for the user's interaction with the application. Additionally, a preferred embodiment provides access to a common set of tonebanks/loops through a centralized server sound library that could measure in the tens to hundreds of thousands of tone-bank/loop options to the user, thus building a framework of sounds that is shared across the user base. Storing the sound library in a centralized manner allows for enhanced capabilities in collaboration between users who wish to manipulate a common work. These users could be from different geographic areas and different computer systems and even different operating systems. Additional features provide a means of remote storage of audio works in a centralized server environment, thereby creating a non-system dependent storage format where an audio work can be created on one operating system and edited on another operating system, in multiple geographic areas.

The concept of a “Tone” as used herein refers to audio sounds that can be actuated independently of another Tone in a controlled manner (tied to a key event or a mouse event), yet the Tones belong to a family of Tones called a Tone-bank. An example of this might be a trumpet tone-bank playing the note C# by depressing the H key, and note C by depressing the G on the keypad of the computer keyboard. Similarly the tones in a Tone-bank may belong to percussion sounds where a snare drum is the sound when the S on the computer keypad is depressed and a bass drum sounds when depressing the B on the computer keyboard.

The concept of a “Loop” as used herein differs from Tones and Tone-banks in this document in that the term “Loop” refers to an audio performance that has been already been digitally captured either external to the application or recorded and stored as a work within the application. The primary actuation and control of a Loop is to have the Loop performed for a duration of time, often allowing the performance to be “looped” together. Examples may be a complex percussion sequence or digitally captured sample of another recording.

In one embodiment of the present invention, the client system navigates its browser to the server system's URL so that the server system can deliver an interactive application to the client system. The interactive application has the ability to interact with the client system's hardware devices such as a sound card, memory, and local storage devices. The server system also stores a library of sound files (tone-banks and loops) that the client can access and retrieve into his or her local memory for interaction with the client's local system.

Once the server system has delivered the interactive application to the client system, the user of the client system decides if he or she wants to either create a new work or retrieve an existing work. The interactive application delivered to the client system provides the user of the client system with the ability to retrieve as well as store works on a remote storage system controlled by the server system, thus providing centralized access to the work. To facilitate various operations, the interactive application on the client system loads sound and files (e.g., mp3, .wav, au) to be incorporated into a work, existing works created by the interactive application (locally or remotely stored), and other file structures such as a MIDI file to support the user in creating works. The option to store the work to the client system's local storage devices is also provided via the interactive application.

In a first pass, assume that the user of the client system wishes to create a new work. The interactive application defaults to a new work that has no sounds applied to any section of the work. The sections that are independently managed in the interactive application can be called a “track.” The user of the client system first identifies a sound that he or she wishes to use which is managed by the interactive application, communicating to the server application. The user of the client system is provided multiple options to access sound files either on a remote library of sounds managed by the server system on files stored on the client system's local storage devices. Once the user of the client system has identified the sound file desired, he or she applies the sound to a specific track in the interactive application's interface. Once the sound file is mapped to a track, the user can then either click on an active part of the application using the mouse or activate the sounds in the selected sound file by actuating the keys on the client system keyboard.

Whether the user has decided to create a new work or edit/add to an existing work, the interactive application allows the user of the client system to select a section of the work, e.g., a track, with which to interact. If the work has existing actuation events in the track and a sound to perform against the actuation events has been identified, the user has option to edit the selected the track, perform the track, or erase the actuation events stored on the track.

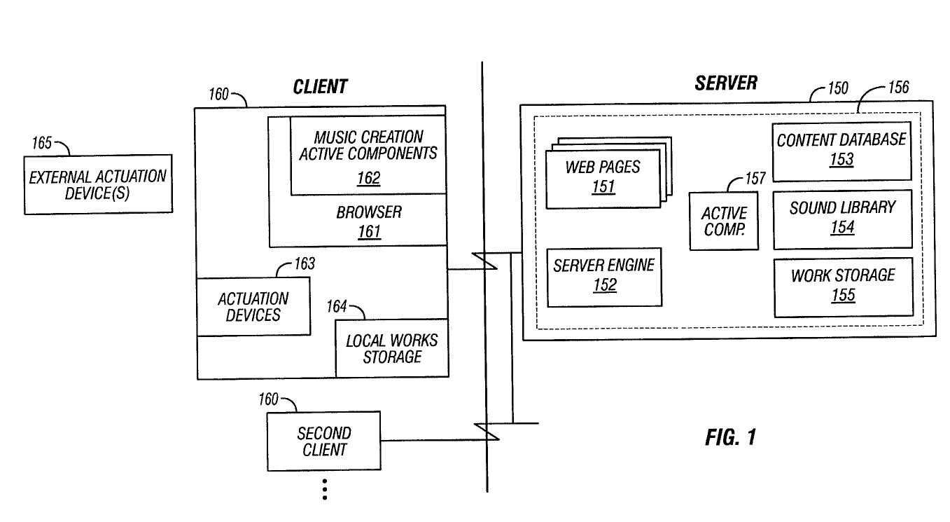

FIG. 1 is a block diagram illustrating apparatus useful in practicing an illustrative embodiment of the present invention. This apparatus supports the delivery of an active software component 157 from a server system 150 to a client system 160 over a network such as the World Wide Web. The active software component 157 may reside on the hard drive 156 of a conventional server system 150 or on other local or remote storage. In FIG. 1, an active component 162 is illustrated as already having been transferred to the client 160. As those skilled in the art may appreciate, the server system 150 of the illustrative apparatus further comprises a first computer, which may be termed a “control” computer, while the client system 160 comprises a second computer. Additional client systems 160 may receive the active component 157 and otherwise interface with the server system 150.

The server system 150 includes various Web pages 151, a server engine 152, a content database 153 including pointers to sound files, a storage area for a sound library 154, and a storage area 155 for the user files to support remote storage of user works. The server engine of the system 150 receives HTTP request to access Web pages identified by URLs and provides the Web pages to the various client systems, e.g., 160. An HTTP request is made by a user of the client system in order to gain access to the active components to create music works. The content database 153 supports listing the various sounds in the sound library 154 made available through the sound library storage on the web pages displayed on the client system 160.

The client system 160 contains a browser 161 that supports the instantiation of and controlled access to the music creation active components 162. Various activation devices 163 are provided such as the client system keyboard or the client system mouse. The client system 160 also provides a means of locally storing music works created on the client system 164. Additionally, actuation devices 165 external to the client system 160 can be plugged in through ports in the client system 160 such as MIDI ports or USB ports. These external devices 165 could comprise a traditional electronic keyboard or a drum machine.

One skilled in the art will appreciate that the techniques involved in delivery of these active components from a server system and a client system can be accomplished in various environments such as a company's local area network, point-to-point dial-up networks, or networks that deliver applications to hotel room televisions. Also, the server system—client system interaction may involve a subscription model that stores user information such as access rights to various tones and loops in the sound library 154 or access rights to versions of the active components and add-on applications within a client system solution. Concerning alternatives for the client system 160, a client system can comprise wireless devices such as a cellular phone or handheld device that allowed for application delivery and instantiation via a wireless network. Actuation of the tones may be through the keypad or an external peripheral device.

Additionally, while FIG. 1 illustrates components 151-155 residing on the system server's hard drive, such is not necessarily required, i.e., the sound libraries would more likely be stored on a remote file server with mappings from the main web server (system server), thereby lowering the cost of storing multiple instances of the library. Also, the database is likely to be stored on a separate database server. The works storage can be outside the network on a third party server that specializes in remote storage. These various configuration options still serve conceptually as the server system. Any deviation from a single physical server and hard drives on that server are for optimizations in performance and cost reduction.

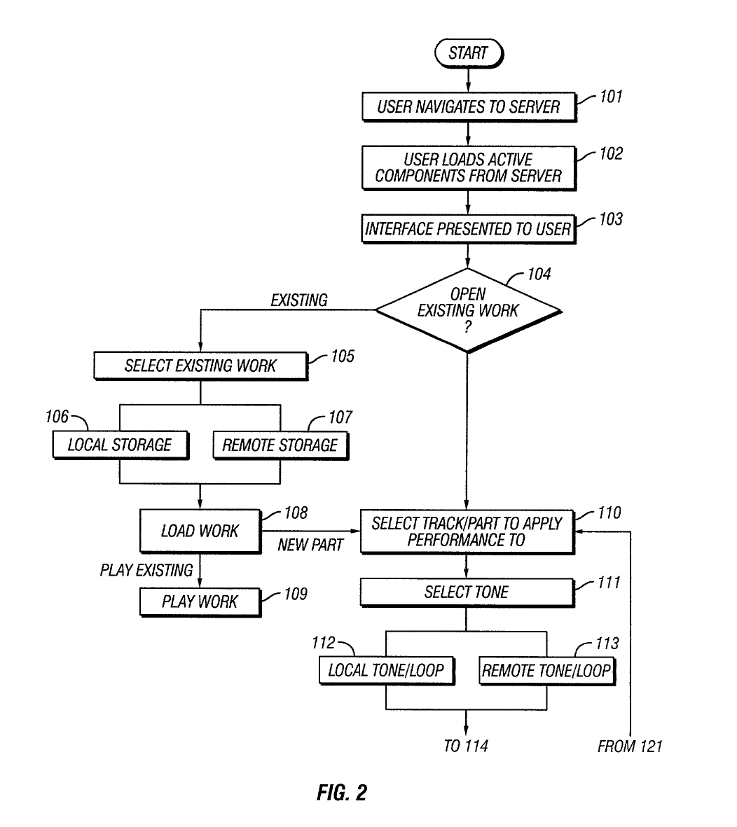

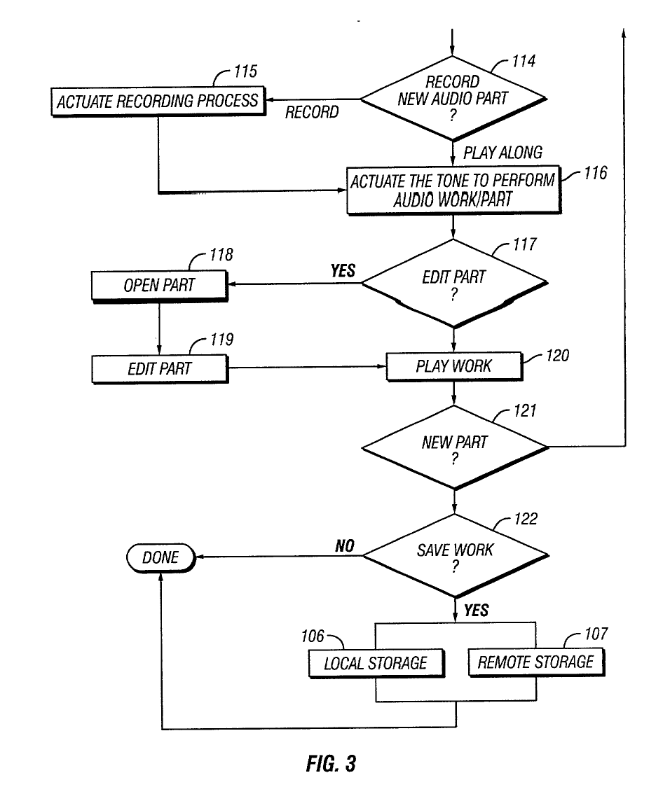

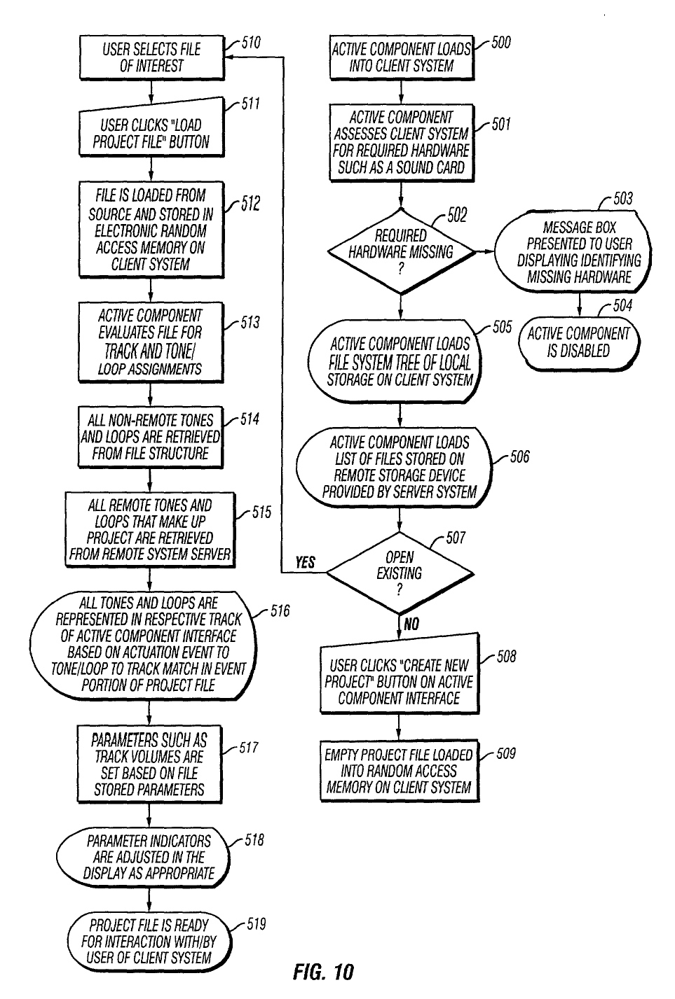

FIGS. 2 and 3 illustrate a procedure for using apparatus such as that illustrated in FIG. 1 to create and edit a music work. In this example, in step 101, the client system 160 navigates to the server system 150, and the server system 150 then presents an active component to the client system 160. In step 102, the client system 160 loads the active component 102. Once the active component is initiated on the client system 160, a user interface is presented 103. The user interface may include a “virtual recording console” as shown in FIG. 10.

The user of the client system 160 has the option to open an existing work which has been previously created or to create a new work, which option is exercised at decision diamond 104. If the user of the client system 160 chooses to open an existing work, step 105, the user has the option of loading the work from the client system 160, calling local storage (step 106) or downloading the work (step 107) from a remote storage system, which can be provided by the server system 150.

Once the work is identified on the chosen storage option, the work is loaded (step 106) into the client system's active component environment 162. The user can then perform the existing work as desired, step 109, or add a new part to or edit the existing song or by selecting the Track/Part to be interacted with using the active component at step 110. Step 110 is also the first step in creating a new track/part from a new song 110.

Once the track/part has been selected, the user of the client system 160 proceeds at step 111 to select either a tone or a loop that will be activated (“played”) during the creation of the song part. These tones or loops can either be stored locally to the client system 112 or remote on the server system 113. Once selected and loaded into the client system's active component 162, the user can begin using the tone/loop by either listening to it or recording it, an option which is exercised at decision diamond 114. The option to record the part performed is available to the user by actuating the recording process in the client system's active components via a recording control panel 115 or, if recording is not desired at that particular time, the user may simply play the part without recording the performance. Once the option to record has been exercised at 114, the user of the client system then actuates the tones/loops to using the client system's computer keyboard or an external actuation device 116.

If the user was recording the performance or wished to edit a different part/track that was previously performed and recorded, he or she has the option to do so, which is exercised at decision diamond 117. Editing a track/part may take the form of selecting a new tone and re-performing the part or simply opening the part and applying an audio effect such as reverb or echo to the part, which would not require re-recording. At any time in the creation and editing of a work, the user of the client system can play back all or some of the tracks/parts 120. This process of editing and adding new parts through the use of the active components on the client system may be repeated, step 121, until the user is satisfied with the work or wishes to save the song at step 122. The song can be saved on the client system 160, step 106, or on a remote storage device such as may be present on the server system 150 (step 107).

One skilled in the art will appreciate that the process for creating the music work via a network delivered application could be accomplished in various methods such as downloading a complete work into the application without a vocal arrangement, thereby creating a Karaoke style recording option; allowing for the user of the client system to add their own vocal recording accompanied by the work and the lyrics presented via a screen in the network delivered application; or presentation of storage methods such as writing the work to a recordable compact disc (CDR).

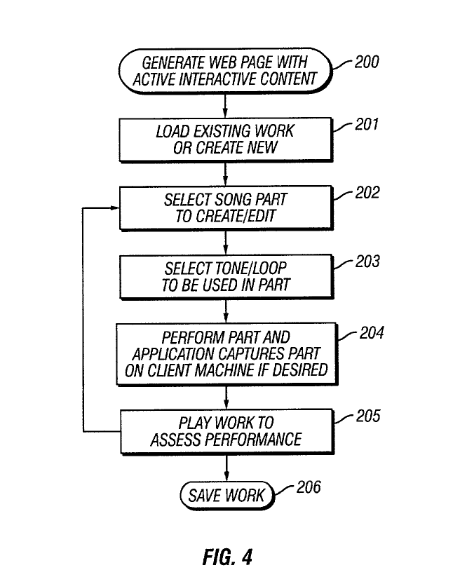

FIG. 4 is a flow diagram setting forth the primary steps in the creation, editing and storage of a music work in one embodiment of the present invention. One of the primary aspects of the present invention is the delivery of an active component to the users client system 200. This process allows for greater control in application access, version improvements and upgrades. Add-on applications can be effectively deployed on the user's client system throughout the lifecycle of use. Numerous programming environments support the delivery of Interactive content via a Web Browser such as Microsoft's ActiveX technologies, Java Applets and Applications, and Macromedia's Shockwave technologies. New programming environments for developing active content will likely be developed in the future, which can further enhance the development and deployment of active components to support the present invention.

In step 201, the user of the client system is given the opportunity to create a new work or open an existing work. This work can be stored in numerous manners both local to the client system and remote to the client system. This flexibility greatly enhances the flexibility to share works among users of the client system as well as improves the availability of the works for users who use multiple client systems in geographically different areas. Once the user opens or creates a work, he or she begins by selecting a new or existing part of the song to begin developing, step 202. The term “track” typically refers to a section of a song which has a unique function within the song such as a Drum Track, or a Bass Track, or Violin Track. The division of parts of the song facilitates micro-editing of the parts and adjustments in the volume of the part. Each part takes advantage of either a loop, which typically is a pre-recorded part which can be repeated over and over for a specified period of time or a tone, which is a sonic reproduction of a music instrument or sound effect that when actuated plays a note or sound based on the tone. Examples of tones are a sonic representation of a trumpet or guitar or a snare drum.

Another primary aspect of the method and system is providing the user of the client system access to numerous tones and loops, which they can select and apply to a track, step 203. By having these tones and loops centrally stored for all client systems, works created on the client systems can be more easily shared among users of the client systems as well as made available to the users of the client systems in differing geographic areas, independent of the specific instance of the client system.

Once the tone/loop has been selected and applied to the track, the user of the client system can begin manually interacting with the actuation devices on the client system or external to the client system. This action can be performed either as a play along performance with the other tracks/parts in the song or performed independent of the other tracks/parts of the songs. Additionally, the user is able to record the actuation events, step 204, which allows for automatic playback at a later time. The work can be loaded from anywhere onto a client system, step 205. Moreover, the user can save the work in various manners thereby enhancing the access to the song from various client systems or store the work local to a single client system, step 206. One skilled in the art <will appreciate that the process may be modified in various combinations such as selecting the tone/loop prior to the track part and then assigning the tone/loop to a track/part through a drag and drop action of a pointing device on the client system. Similar performance of any track may be accomplished at any time after the song is loaded into the client system's active application components.

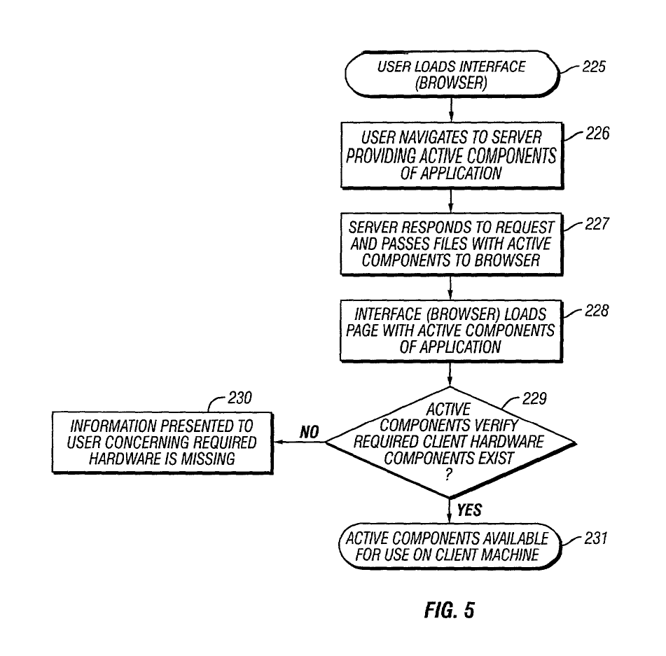

FIG. 5 is a flow diagram illustrating delivery of the active components to a client system in one embodiment of the present invention, for example, as indicated in steps 101, 102, and 103 of FIG. 2. The user begins at step 225 by launching a supporting environment on the client system such as a Web Browser. This controlled environment on the client system may be any application delivery environment that is supported within the client system—server system network. Using the client system's supporting environment such as a Web Browser, the user navigates to the server system that stores the Active components of the application, step 226. The server system 150 identifies the request and performs any required authentication to establish authenticity of the request by the user and then, in step 227, passes the active components from the server system 150 to the client system 160. The Web browser on the client system 160 performs any instantiation processes and loads the active components into the Web browser on the client system 228.

Any required hardware devices or software that must be present for the active components to perform properly can be verified as to their presence in the client system 229. Examples of these kinds of hardware devices are a computer sound card or a computer keyboard. An example of software that may be required is a Java runtime environment. If the required devices or software are not present, the active components provide a warning to the user of the client system informing them of the deficiency 230, and, if the deficiency is software-based, provides assistance to the user of the client system 160 in loading the required software. Provided that all the required hardware and software is present, the active components on the client system are made available for use as shown in step 231.

One skilled in the art will appreciate that the process for deploying and initializing the active components on the client system can be accomplished in various manners. The user may already have the location of the server 150 built into the client system supporting environment thereby eliminating the requirement to navigate to the server 150. This arrangement would be especially convenient in a kiosk environment such as a school music program where the client system 160 is dedicated to the client system—server system arrangement, in which case the software and hardware check may not be required since the systems were developed as a dedicated pair and all the required hardware and software can be assumed.

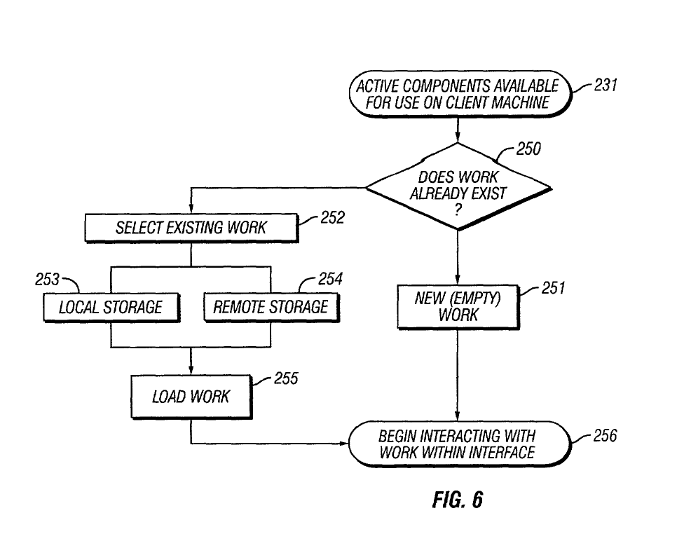

FIG. 6 is a flow diagram detailing interaction with existing works and new works on the client system. Once the client system has the active component applications loaded in the Web browser and available for use at point 231, the user must decide at decision diamond 250 if the user wants to create a new work, step 251, or load an existing work, step 252, into the client system environment. In the case that a user wishes to create a new work, a clean environment is loaded into the application's memory and be made available for creating parts in a new song. In the case that the user wishes to select an existing work (step 252), the user has the option to load the existing work from a local storage device 253 or a remote storage device 254. Local storage devices could be any device internal or attached to the client system that has the ability to store files. Examples of local storage devices could be a computer hard-drive or computer CDROM. Since local storage may limit the user's ability to load a work that was created on a different client system, the option for remote storage is also provided. Examples of remote storage include storage on the server system that holds the active components delivered to the client system 160 or additional storage systems that are put into use in conjunction with the server system 150 that houses the tones and active components.

Once the existing work is located, the work is loaded into the client systems active component environment at step 255. Once loaded, the work is available for performance or editing.

One skilled in the art will appreciate that the process for loading an existing work or creating a new work on the client system can be accomplished in various manners. For example, the user can be presented a clean environment initially allowing for immediate development of a new work and only then be “asked” if he or she would like to load an existing work. Similarly, as a convenience to the user, the last work with which the user has interacted can be loaded first, and the user can thereafter open a different work or create a new work, if so desired.

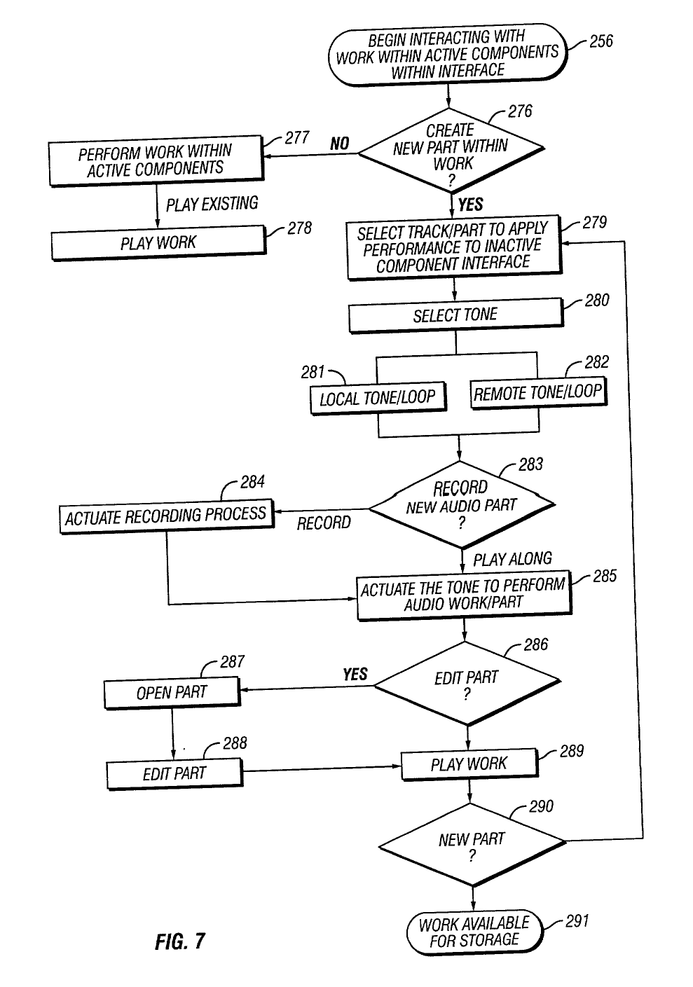

FIG. 7 is a flow diagram detailing user-client-system interaction in selecting an existing part in a work and creating a new track/part in a work on the client system. Once the user has decided to create a new work or load an existing work, the user next decides if he or she wishes to create a new part or play an existing work as is, step 276. Should the user have existing parts which the user wishes to simply perform, the user interacts with the client system active components, step 277, to cause the application to play the parts of the songs in parallel, step 278. Playing a work can be accomplished at any time when the client system is not in a record mode.

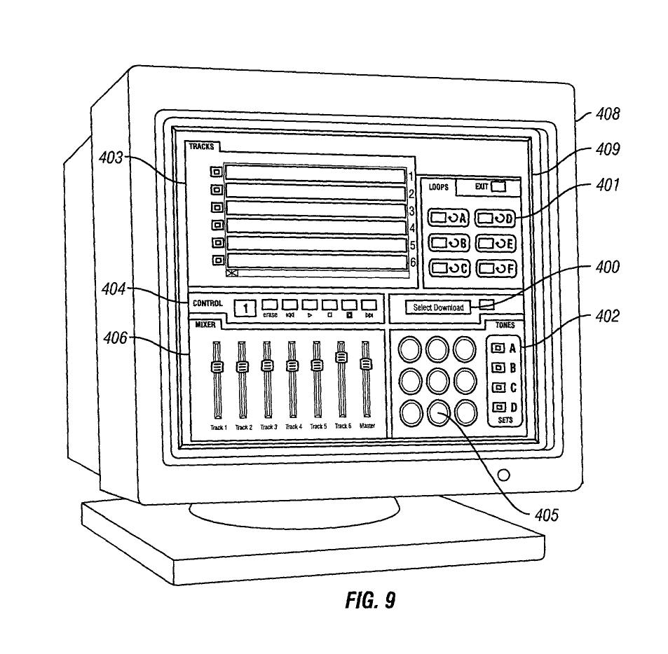

Typically a song is separated into multiple parts, often called tracks, to allow for greater control in editing and manipulating parts. When the user decides to create a new track/part, the user first identifies an available track/part that is open 279. Once the track/part is selected, the user must identify a tone or loop to be copied (recorded) to form the new track or part, step 280. Tones and loops are selected from the local source 281 or a remote source such as the server system 282. Remote tones and loops provide additional advantages, as all users have access to the remote sources allowing for improvements in collaboration and mobility. Once the user of the client system selects the tone, the user decides at decision diamond 283 whether to record the performance (e.g., “song”) by activating a recording control (e.g., clicking the Record button on the active software component interface, for example, on FIG. 9, indicator 404), step 284, or just play the performance by activating the play control, step 285. Performing a part using a loop is accomplished by actuating an input device on the client system 160, for example, by pressing down a key on the keyboard or clicking on a section of the active software component interface (e.g., click once on the loop play button, click again to stop the loop, for example, on FIG. 9, indicators 404) with the mouse 285. External devices from the client system such as an electronic piano/keyboard could also be used.

Once the user of the client system has completed the performance, he or she can stop the recording or playing of the song and return the location of the start point to the beginning through the client system's active component interface song navigation controls (as seen on FIG. 9, indicators 404). Thereafter, the user continues interacting with the song, creating and editing new parts, step 286, by selecting the track/part and opening the event, step 287, editing the part by applying effects or moving actuation events, step 288, and then replaying the song to listen to how it sounds with the changes, step 289. This process of editing and creating new parts 290 continues until the user of the client system 160 is finished with the song and wishes to save the work 291.

One skilled in the art will appreciate that the process for adding and editing parts within a work on the client system 160 can be accomplished in various manners. For example, the user of the client system 160 can select a tone/loop and then drag the iconic symbol for the loop onto the track in a one step process, thereby eliminating the two-step process of selecting the track and then selecting the loop. Other combinations of creating, editing and performing tracks/part and interchanging tones or loops based on the events can also be supported, thereby separating the actuation events and the tones/loops that applied to the events.

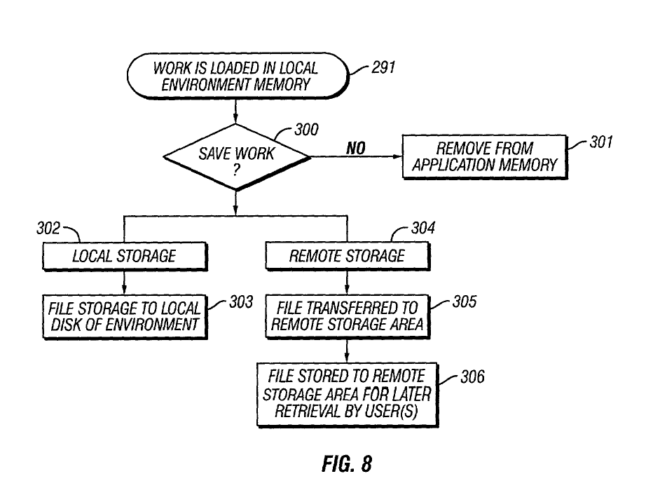

FIG. 8 is a flow diagram illustrating saving a work through the client system 160. After the work has been loaded into the client systems active components at step 310, and after edits and additions have been accomplished, the user may wish to save the work, step 300. As with opening an existing work, options are provided for selecting local storage, step 302, or remote storage, step 304, regardless of where the file was opened or created. Should the user of the client system 160 choose a local option, the user can take advantage or numerous storage devices on the local machine such as the hard drive, removable drives or a recordable CDROM. By choosing the remote option, step 304, the user transfers the file through the network, step 305, to the desired remote storage option such as the server system 150 or another remote storage location. Having the remote storage option further expands the availability of the work to other users of other client systems or from other geographic locations that have access to the client system 160. Should the user not wish to save the work, the user can simply close the active component down on the client system, step 301.

One skilled in the art will appreciate that the process for saving works on the client system can be accomplished in various manners. For example, the user of the client system can share the work in a peer-to-peer environment allowing for asynchronous editing of the work where either peer using the client system could save the work or both save the work. Control of the editing of the work would be managed between the client systems and between the users. Additional storage options such as wireless devices also allow for storage that can support mobility at the same time as locally oriented storage.

FIG. 9 provides an example of an interface 409 of a working active component application on the client system 160 according to one embodiment of the present invention. The interface 409 presents various controls interfaces provided to the user of the client system, typically on a computer-controlled display screen or panel 408. A number of loop selector buttons 401 provide the user with the ability to select a loop to actuate and assign to a track. A tone/loop download button 400 provides the user with the ability to select new tones and loops to download and assign to a track. A number of tone selector buttons 402 provide the user with the ability to select a tone to use for creating a part. A number of track selector buttons 403 provide the user with the ability to select/assign a part within the song with which to interact. Song control selector buttons 404 provide the user with the ability to interact with the song for playback, fast forward, rewind, record, and erase. Tone actuation pads 405 are also provided to give users a graphical interface to actuate a tone. As noted elsewhere herein, actuation from keyboard keys is also provided. Finally, volume adjustment buttons 406 provide the user with the ability to dynamically adjust the volume of a track within the song.

This example interface supports multiple Tracks that can be activated and deactivated by clicking on the iconic symbol to the left of the beginning of the track. Once the track is selected the user can select either a loop or a tone. The length of performance of a loop is controlled by clicking on the iconic symbol 401 once to start and once again to stop. Tones, on the other hand, deliver a set of sounds that are actuated by a device on the client system. The interface provides graphics in the shape of a pad 405 for the user to click-on with the mouse, each pad 405 performing a different sound in the tone bank. Actuation of each of the pads 405 can be also accomplished by pressing the numbers 1-9 on the client system's keyboard. Additional loops and tones can be downloaded from a remote system and assigned to a selected track. Recording, erasing, playing, reverse and fast-forward of the song are controlled in the controls section 404 of the client system active component interface. The active track/part is indicated in the interface. Volume controls 406 are provided to allow for mixing of the playback of the tracks. Mixing can be accomplished dynamically as the song is playing.

One skilled in the art will appreciate that the interface for the active component provided to users of the client system could be developed and presented in various manners. For example, the volume mixing board can be a separate module that is presented as needed to provide greater room to manage the tracks. Or tone and loop selection options can be provided in a tree structure organized by tone or loop type and the user may drag the loop desired onto the track for assignment. Also, for micro-editing, the user may click on the track and open the track for micro-editing in a supporting module in the client system's interface. The interface shown is thus merely illustrative of many types of interfaces which may be provided. Interfaces can be provided on numerous client systems such as a cellular phone or personal digital assistants, thereby drastically changing the layout of the required interface.

FIGS. 10-16 illustrate the structure and operation of an active component enabling user-actuation and manipulation of audio sounds. In step 500 of FIG. 10, the active component loads into the client system. In step 501, the active component assesses the client system for required hardware such as a sound card. In decision diamond 502, the decision is made whether required hardware is missing. If the decision is “yes,” in step 503 the message box is presented to the user displaying identifying missing hardware, and in step 504, the active component is disabled. If the decision is “no,” in step 505, the active component loads the file system tree of local storage on the client system. In step 506, the active component loads the list of files stored on the remote storage device provided by the server system.

At decision diamond 507, the decision is made whether or not to open existing files. If the decision is “no,” in step 508, the user clicks the “create new project” button on the active component interface. In step 509, an empty project file is loaded into the random access memory on the client system.

If the decision made at decision diamond 507 is “yes,” in step 510, the user selects a file of interest. In step 511, the user clicks the “load project file” button. In step 512, the file is loaded from the source and stored in the electronic random access memory system on the client system. In step 513, the active component evaluates the file for track and tone/loop assignments. In step 514, all non-remote tones and loops are retrieved from the file structure. In step 515, all remote tones and loops that make up the project are retrieved from the remote system server. In step 516, all tones and loops are represented in respective tracks of the active component interface. An indicator such as a tick mark identifies that an actuation event has been recorded at the time interval presented in the active component interface. The recorded actuation events have a corresponding tone/loop that is to be performed on playback as part of the vent structure.

In step 517, parameters such as track volumes are set based on file stored parameters. In step 518, parameter indicators are adjusted in the display as appropriate. In step 519, the project file is ready for interaction with the user of the client system.

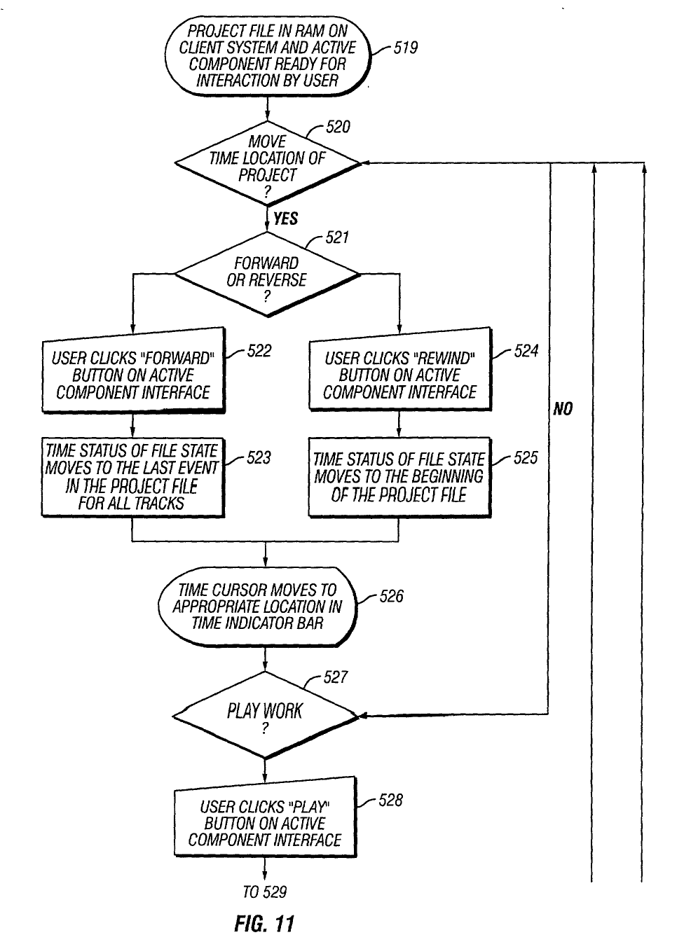

In FIG. 11, at decision diamond 520, the decision is made whether to move the time location of the project. If the decision is “yes,” at decision diamond 521, the decision is made whether to move the time location of the project forward or reverse. If the decision is made to move the time location of the project forward, at step 522, the user clicks the “forward” button on the active component interface. In step 523, the time status of the file state moves to the last event in the project file for all tracks. If the decision is made to reverse the time location of the project, in step 524, the user clicks the “rewind” button on the active component interface. In step 525, the time status of the file state moves to the beginning of the project file. In step 526, the time cursor moves to the appropriate location in the time indicator bar of the active component interface.

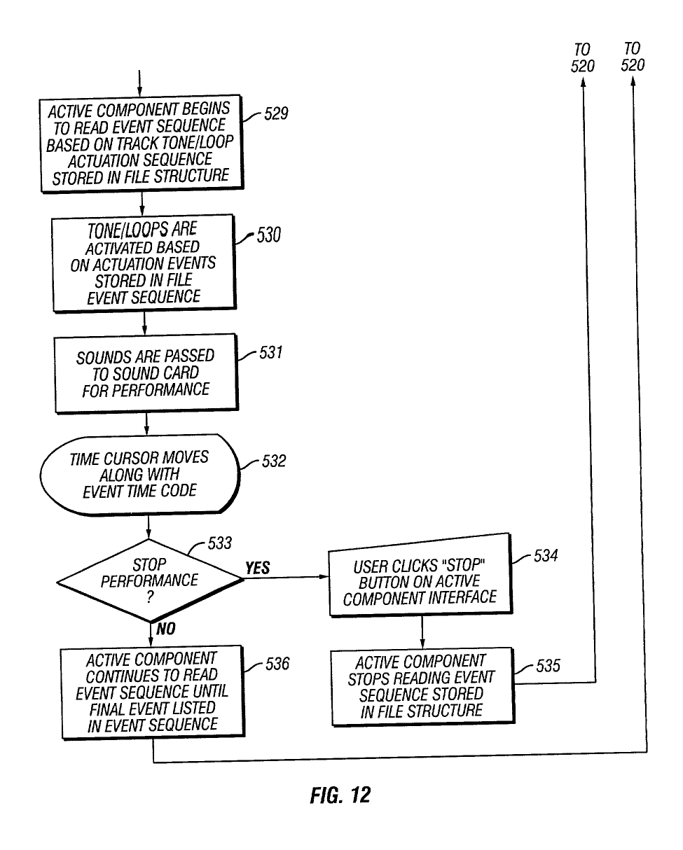

At decision diamond 527 of FIG. 11, the decision is made whether or not to play the work. If the decision is “yes,” in step 528, the user clicks the “play” button on the active component interface. The flow then proceeds to step 529 of FIG. 12, where the active component begins to read the event sequence based on the track, tone/loop, actuation sequence stored in the file structure. In step 530, the tone/loops are activated based on actuation events stored in the file event sequence. In step 531, the sounds are passed to the sound card for performance. In step 532, the time cursor moves along with the event time code. In decision diamond 533, the decision is made whether or not to stop the performance. If the decision is “yes,” in step 534, the user clicks the “stop” button on the active component interface. In step 535, the active component stops reading the event sequence stored in the file structure. If the decision is “no,” in step 536, the active component continues to read the event sequence through to the final event listed in the event sequence.

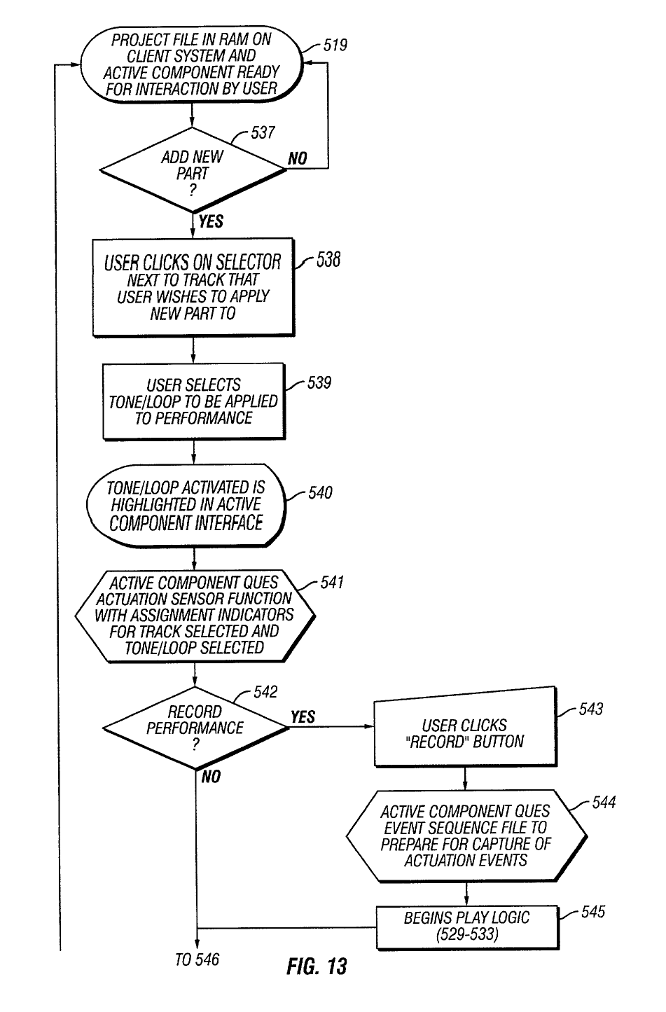

In FIG. 13, at decision diamond 537, the decision is made whether to add a new part to the audio performance. If the decision is “yes,” in step 538, the user clicks on the selector next to the track to which the user wishes to apply a new part on the active component interface. In step 539, the user selects the tone/loop to be applied to the performance. In step 540, the tone/loop which has been activated is highlighted in the active component interface. In step 541, the active component cues the actuation sensor function with the assignment indicators for the track selected and the tone/loop selected. Placing the active component in this sensory state allows the software to await the user instructions (through actuation events) for performing the tone/loop based on the event mapping within the tone/loop set. Tones sound a specific note or tone, while loops play for the duration of the start/stop actuation pair.

At decision diamond 542, the decision is made whether or not to record the performance. If the decision is “yes,” in step 543, the user clicks the “record” button. In step 544, the active component cues the event sequence file to prepare for the capture of actuation events. In step 545, the active component executes the play logic of steps 529-533.

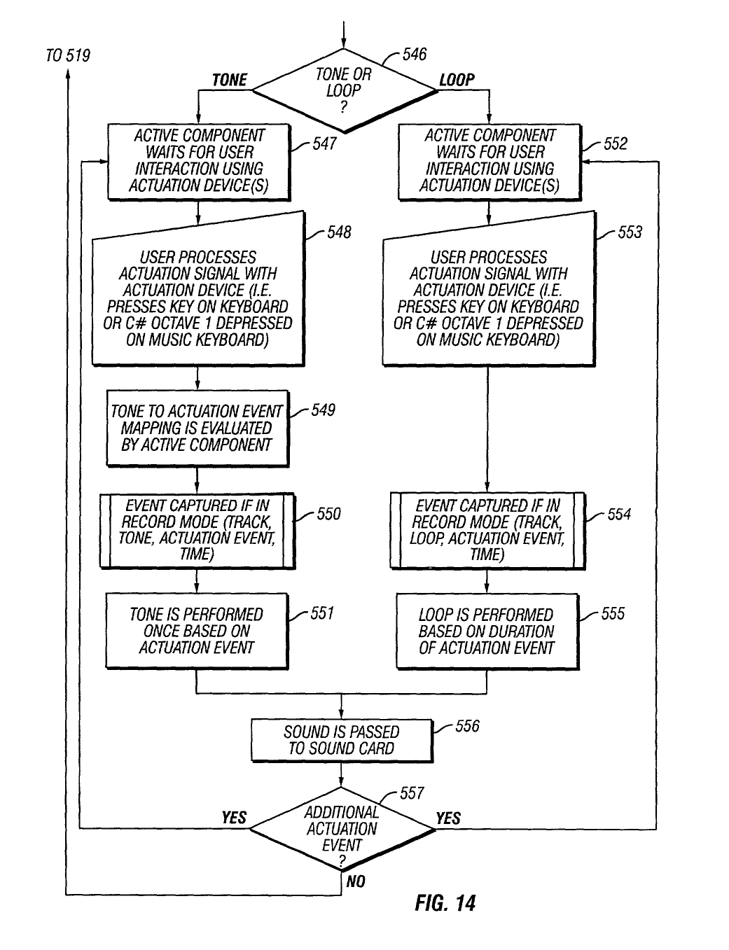

If the decision at decision diamond 542 is “no,” the decision is made at decision diamond 546 (FIG. 14) as to whether to record a new tone or a loop. If the decision is made to apply a tone, in step 547, the active component waits for the user interaction with the user actuation devices. In step 548, the user generates the actuation signal with the actuation device, for example, by depressing a key on a keyboard or supplying MIDI events.

In step 549, the tone-to-actuation event mapping is loaded by the active component. The tones are mapped to actuation events according to parameters stored with the tone bank. For example, pressing on key “1” on the computer keyboard generates a base drum sound, while pressing on “2” may generate a snare drum. In one embodiment, keys “1” through “9” map to a specific drum sound. In the case of a trumpet, pressing the “G” key on the keyboard may sound the note C#, while the “N” key a G#. This tone-to-event mapping is important, as it separates the tone functionality from a loop, which only plays for a duration based on the user's interaction. The event mapping is loaded so that the active component knows what events map to which tone, which of course can be different for various tone sets. Some tone sets might use keys 19, while others use all four rows on the keyboard.

Proceeding further with the flow of FIG. 14, in step 550, the event is captured if in the record mode. The “event” comprises track, tone, actuation event, and time. In step 551, the tone is performed once based on the actuation event.

If the decision is made at decision diamond 546 to apply a loop, in step 552, the active component waits for the user interaction using the actuation devices. In step 553, the user generates the actuation signal with the actuation device. In step 554, the event is captured if in record mode (track, loop, actuation event, time). In step 555, the loop is performed based on the duration of the actuation event. In step 556, the sound is passed to the sound card. In decision diamond 557, the decision is made whether to have an additional actuation event. If the decision is “yes,” the process loops back to step 547 or step 552. If the decision is “no,” the process returns to step 519.

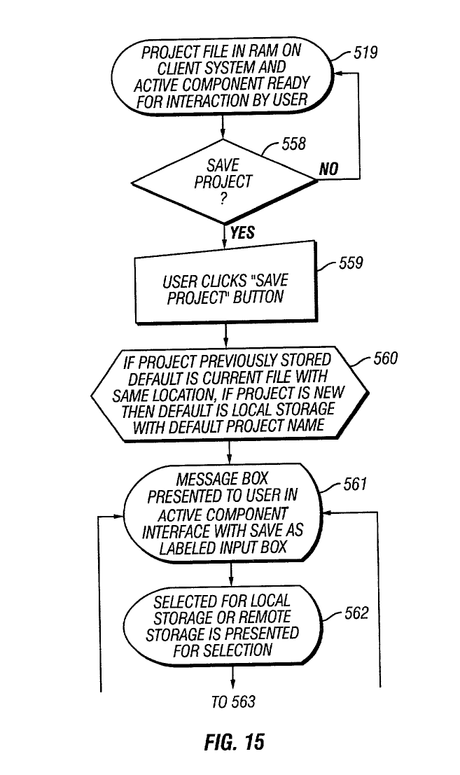

In FIG. 15, at decision diamond 558, the decision is made whether to save the project. If the decision is “no,” the process returns to step 519. If the decision is “yes,” in step 559, the user clicks the “save project” button. In step 560, if the project is previously stored, the default is the current file with the same location; if the project is new, then the default is local storage with the default project name. In step 561, a message box is presented to the user in the active component interface with a “save as” labeled input box. In step 562, the selector for local storage or remote storage is presented for selection.

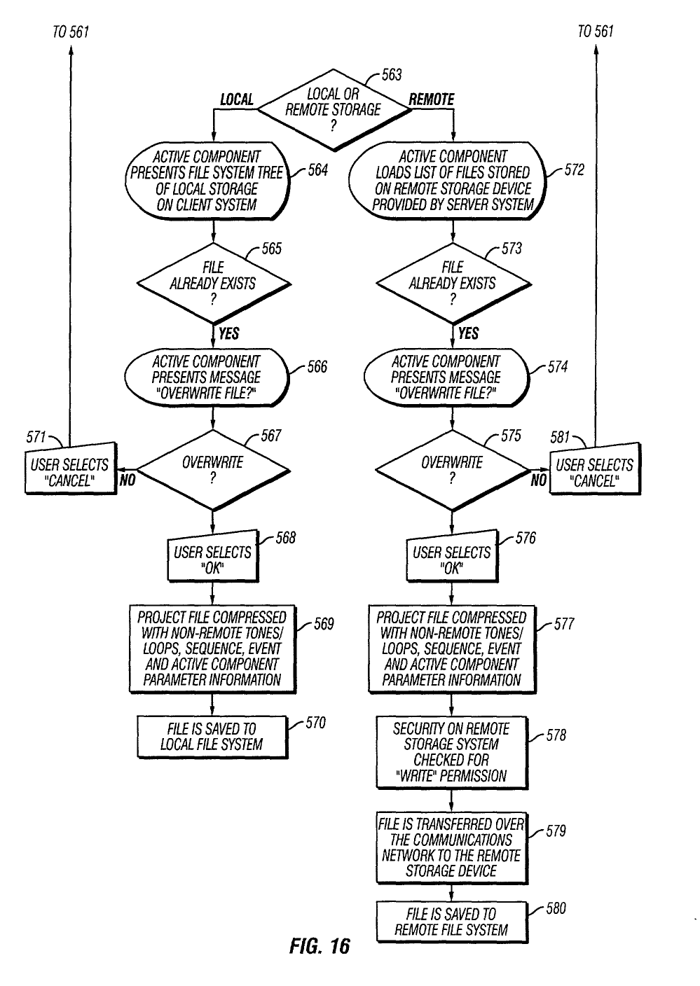

At decision diamond 563 (FIG. 16), the decision is made whether storage will be remote or local. If the decision made is “local storage,” at step 564, the active component presents the file system tree of the local storage on the client system. In decision diamond 565, the question is asked if the file already exists. If the answer is “yes,” in step 566, the active component presents the message “over write file?”. In decision diamond 567, the decision is made whether to over write the file. If the decision is “no,” in step 571, the user selects “cancel.” If the decision is “yes,” in step 568, the user selects “OK.” In step 569, the project file is compressed with non-remote tones/loops, sequence, event, and active component parameter information. In step 570, the file is saved to the local file system.

If the decision made at decision diamond 563 is “remote storage,” in step 572, the active component loads the list of files stored on the remote storage device provided by the server system. At decision diamond 573, the question is asked if the file already exists. If the answer is “yes,” in step 574, the active component presents the message “over write file?”. At decision diamond 575, the decision is made whether or not to over write the file. If the answer is “no,” in step 581, the user selects “cancel.” If the answer is “yes,” in step 576, the user selects “OK.” In step 577, the project file is compressed with non-remote tones/loops, sequence, event, and active component parameter information. In step 578, the security on the remote storage system is checked for “write” permission. In step 579, the file is transferred over the communications network to the remote storage device. In step 580, the file is saved to the remote file system.

It may be noted that reference to “active components” herein contemplates a particular embodiment wherein the total functionality of the active component 162 (FIG. 1) is divided into application modules or “components.” Such division allows for downloading the functionality as needed. For example, since one doesn't need an interface which assists with mixing the different tracks until the end of creation of a song, it is unnecessary to download that functionality with the core module, since one can click a button and obtain the interface when needed. Such an embodiment is merely an alternate embodiment which assists in minimizing download times.

The methods and apparatus of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention or certain aspects thereof. The methods and apparatus of the present invention, or certain aspects thereof, may also be embodied in the form of program code that is transmitted over some transmission medium, such as over electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the present invention has been described above in terms of specific embodiments, it is to be understood that the invention is not limited to the disclosed embodiments. On the contrary, the present invention is intended to cover various modifications and equivalent methods and structures included within the spirit and scope of the appended claims.

The scope of the present invention is according to be limited by nothing other than the appended claims.

What is claimed is:

1. A system for creating an audio work comprising:
at least one first computer connected to a computer network as a control computer;
at least one second computer connected to the computer network;
a sound performance device associated with said second computer;
a computer program storage device associated with said control computer; and
a program stored on the program storage device and executable by said control computer for delivering an interactive computer program to said at least one second computer, said interactive program enabling the activation and manipulation of audio sounds by a user of said at least one second computer.

2. The system of claim 1, wherein the control computer provides remote storage of files retrievable by said at least one second computer.

3. The system of claim 1, wherein the interactive computer program enables the local storage and retrieval of files by said at least one second computer.

4. The system of claim 1, wherein the control computer provides access to sound library files to said at least one second computer.

5. The system of claim 1, wherein the interactive computer program enables access to sound files stored on said at least one second computer's local system.

6. The system of claim 1, wherein the interactive computer program enables a selection of an individual part of an audio work and manipulation of that part without disturbing the other parts of the work.

7. The system of claim 6, wherein the interactive computer program enables retrieval of a sound from a remote storage system controllable by said at least one second computer and further enables application of said sound to said individual part.

8. The system of claim 7, wherein the interactive computer program is responsive to user manipulation of a device to apply said sound and wherein said device comprises one of:
(a) the second computer's mouse;
(b) the keys on said second computers computer keyboard; or
(c) an external hardware device physically or remotely connected to said second computer.

9. The system of claim 8, wherein the interactive computer program enables capturing or recording of said sound.

10. The system of claim 9, wherein the interactive computer program enables replaying the captured sound.

11. The system of claim 1, wherein the interactive computer program enables modification of the captured sound.

12. A system according to claim 11, wherein said interactive computer program further enables:
adjusting the volume of said sound; and
applying a digital audio effect to the sound.

13. A method comprising:
installing an interactive computer program application on a first computer, said program enabling a user of a second computer to manipulate audio sounds so as to create music; and
responding to a user request by delivering said program via a communications network to said second computer.

14. The method of claim 13 wherein the user of the second computer:
is provided a display of a plurality of audio components to be downloaded to the second computer under the management of the first computer from a centralized storage system controllable by said first computer.

15. The method of claim 13 wherein said audio components include a plurality of tones.

16. The method of claim 15 wherein said audio components further include a plurality of loops.

17. The method of claim 14 wherein said audio components include a musical work.

18. The method of claim 13 wherein the user of the second computer can share outputs, products, or works with other users of other computers through storage of the outputs, products or works in a common storage area.

19. Computer software recorded on a tangible storage medium, said software comprising:
an interactive computer program downloadable to a user computer, said program enabling the user to create and record music; and
a process responsive to a user request for said program to transmit said program to the user computer.

20. A system for creating an audio work comprising:
at least one server system connected to a computer network;
at least one client system connected to the computer network;
a sound performance device associated with said client system; and
a program stored on the program storage device and executable by said server system for delivering an interactive computer program to said at least one client system, said interactive program enabling the activation and manipulation of audio sounds by a user of said at least one client system.

21. The system of claim 20, wherein the server system provides remote storage of files retrievable by said at least one second computer.

22. The system of claim 20, wherein the interactive computer program enables the local storage and retrieval of files by said at least one second client system.

23. The system of claim 20, wherein the server system provides access to sound library files to said at least one client system.

24. The system of claim 20, wherein the interactive computer program enables access to sound files stored on said at least one client system's local system.

25. The system of claim 20, wherein the interactive computer program enables a selection of an individual part of an audio work and manipulation of that part without disturbing the other parts of the work.
